(19) United States
(12) Patent Application Publication
(10) Pub. No.: US 2025/0128586 A1
(43) Pub. Date: Apr. 24, 2025

(54) VEHICLE SEAL STRUCTURE

(71) Applicant: HONDA MOTOR CO., LTD., Tokyo (JP)

(72) Inventors: Masahiro TANIGAWA, Wako-shi (JP); Eiji HIRANO, Wako-shi (JP); Makoto ONO, Tokyo (JP); Takeru SATO, Tokyo (JP); Akinari SUZAKI, Tokyo (JP); Shinichi OZAKI, Tokyo (JP); Satoru KUCHIKI, Tokyo (JP)

(21) Appl. No.: 18/914,649

(22) Filed: Oct. 14, 2024

(30) Foreign Application Priority Data
Oct. 19, 2023 (JP) 2023-179980

(51) Int. Cl. B60J 10/86; B60J 10/21; B60J 10/24

(52) U.S. Cl. CPC B60J 10/86; B60J 10/21; B60J 10/24

(57) ABSTRACT

Provided is a vehicle seal structure capable of preventing occurrence of warping and a decrease in sound insulating properties caused by a difference in coefficient of thermal expansion raised by adopting an outer panel made of resin. Simplifying a painting process of the outer panel reduces an exhaust amount of carbon dioxide in vehicle manufacturing, and contributes to mitigation of climate change or reduction of influences thereof. For example, the vehicle seal structure includes the inner panel made of metal forming a door supported to be capable of opening and closing an ingress-egress opening opened on a vehicle side surface; the outer panel made of resin arranged above a plate surface of the inner panel closer to a vehicle outer side to be movable along a door surface of the inner panel; and a seal member held between the inner panel and the outer panel.

### CROSS-REFERENCE TO RELATED APPLICATIONS

This application is based upon and claims the benefit of priority from Japanese Patent Application No. 2023-179980 filed on Oct. 19, 2023; the entire contents of which are incorporated herein by reference.

### BACKGROUND OF DISCLOSURE

### 1. Technical Field

The present disclosure relates to a vehicle seal structure.

### 2. Description of Related Art

Efforts to mitigate climate change or reduce an influence of the climate change have been continued from the past, and research and development on reduction of an exhaust amount of carbon dioxide are being made to achieve this goal.

Among such efforts, research has been carried out for simplifying a painting process such as reducing the number of times of painting on an outer panel forming a design surface of a vehicle.

For example, JP Hei 6-340221A proposes a technique in which an inner panel of a vehicle is made of metal while an outer panel is replaced from an outer panel made of metal to an outer panel made of resin, and the inner panel and the outer panel are joined to each other with an adhesive.

### SUMMARY OF DISCLOSURE

In the method proposed in JP Hei 6-340221A, the inner panel made of metal and the outer panel made of resin vary in coefficient of thermal expansion. Thus, when entire peripheries thereof are bonded to each other with the adhesive, there is a risk of warping of the outer panel.

Accordingly, the configuration in which the inner panel and the outer panel are bonded to each other may be abandoned and changed to a configuration in which the outer panel is supported by a slide clip or the like to allow thermal expansion.

However, when such a configuration is adopted, a space between the inner panel and the outer panel is not sealed, resulting in a risk of a decrease in sound insulating properties.

The present disclosure has been made in view of the above disadvantages, and an object thereof is to provide a vehicle seal structure that can prevent a decrease in sound insulating properties and occurrence of warping caused by a difference in coefficient of thermal expansion raised by adopting an outer panel made of resin.

In order to achieve the above object, a vehicle seal structure according to the present disclosure includes: an inner panel made of metal forming a vehicle body or a door supported to be capable of opening and closing a vehicle body opening portion; an outer panel made of resin arranged above a plate surface of the inner panel closer to a vehicle outer side to be movable along a door surface of the inner panel; and a seal member held between the inner panel and the outer panel.

According to the present disclosure, it is possible to provide vehicle seal structure that prevents a decrease in sound a insulating properties and occurrence of warping caused by a difference in coefficient of thermal expansion raised by adoption of a resin outer panel.

Moreover, simplifying a painting process of the outer panel reduces an exhaust amount of carbon dioxide in vehicle manufacturing, and contributes to mitigation of climate change or reduction of influences of climate change.

### BRIEF DESCRIPTION OF DRAWINGS

FIG. 1 is a perspective diagram showing a vehicle in which vehicle seal structures of embodiments are arranged.

FIG. 2 shows a vehicle seal structure of a first embodiment, and is a cross-sectional diagram along the II-II line in FIG. 1.

FIG. 3 shows the vehicle seal structure of the first embodiment, and is a main portion enlarged diagram of the III portion in FIG. 2.

FIG. 4 shows the vehicle seal structures of the first and second embodiments, and is a cross-sectional diagram along the IV-IV line in FIG. 1.

FIG. 5 shows a vehicle seal structure of a third embodiment, and is a cross-sectional diagram along the V-V line in FIG. 1.

FIG. 6 shows a vehicle seal structure of a fourth embodiment, and is a main portion enlarged diagram of a portion similar to FIG. 3.

FIG. 7 shows a vehicle seal structure of a fifth embodiment, and is a main portion enlarged diagram of a portion similar to FIG. 3.

FIG. 8 shows a modified example 1 of the vehicle seal structure of the first embodiment, and is a main portion enlarged diagram of a portion similar to FIG. 3.

FIG. 9 shows a modified example 2 of the vehicle seal structure of the first embodiment, and is a main portion enlarged diagram of a portion similar to FIG. 3.

### DETAILED DESCRIPTION OF EMBODIMENTS

### First Embodiment

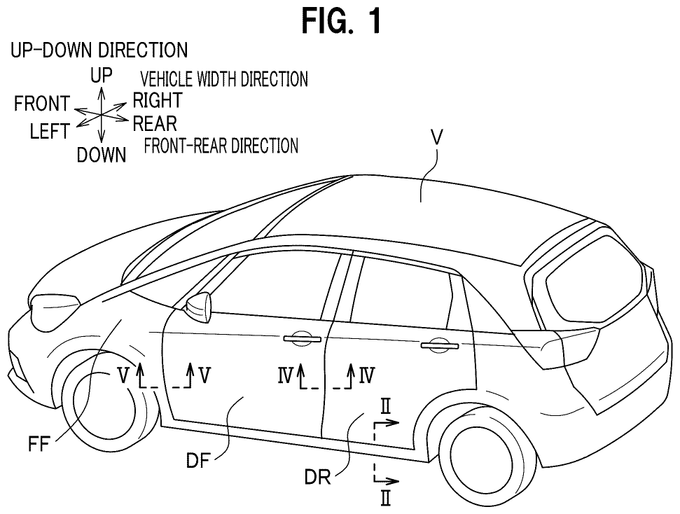

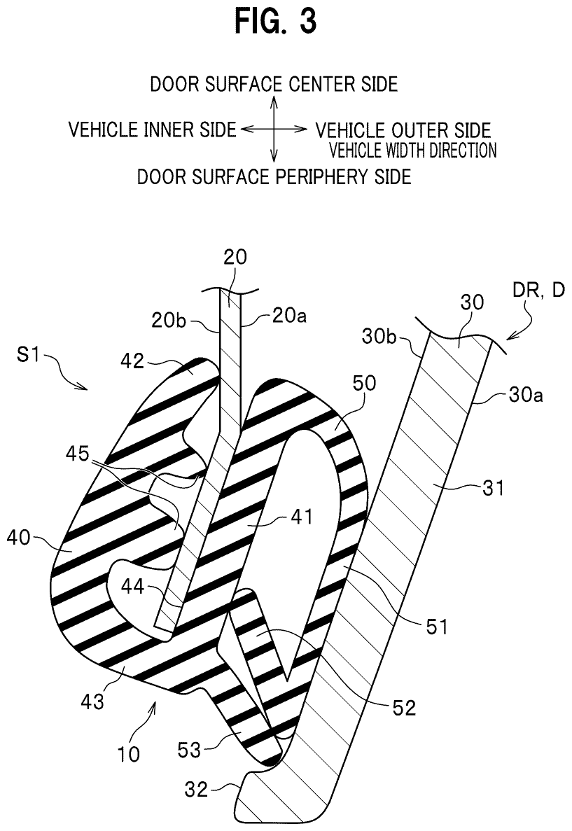

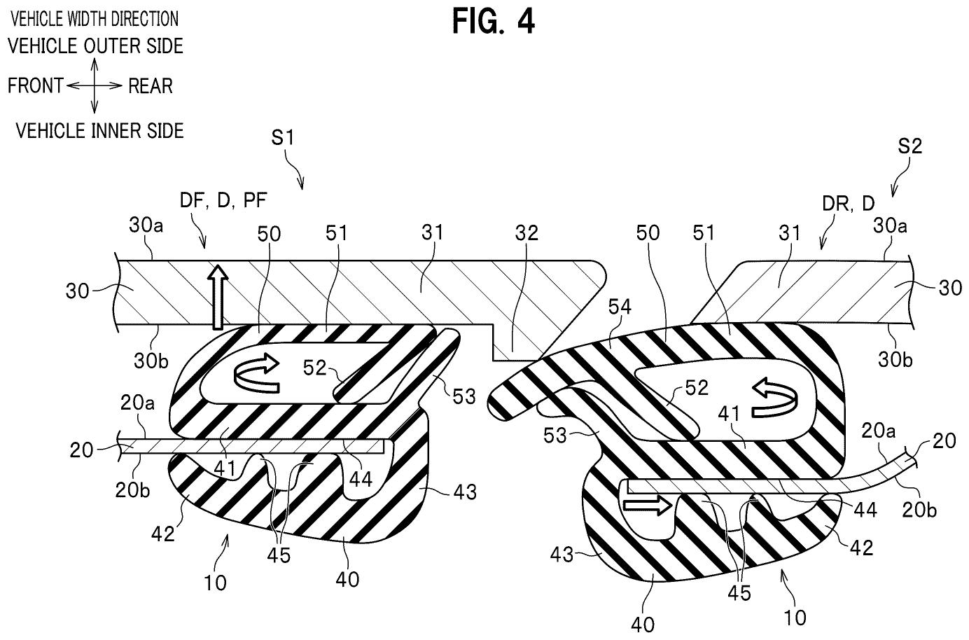

One embodiment of the present disclosure will be explained in detail with reference to FIGS. 1 to 3 and a left portion of FIG. 4. Note that the same elements are denoted by the same reference sign in the explanation, and overlapping explanation is omitted.

A vehicle V includes a front seat door DF that is supported to be capable of opening and closing a front seat ingress-egress opening opened on a vehicle side surface and a rear seat door DR that is supported to be capable of opening and closing a rear seat ingress-egress opening opened on the vehicle side surface (see FIG. 1).

A vehicle seal structure S1 of the present embodiment is set in various portions of door peripheral portions.

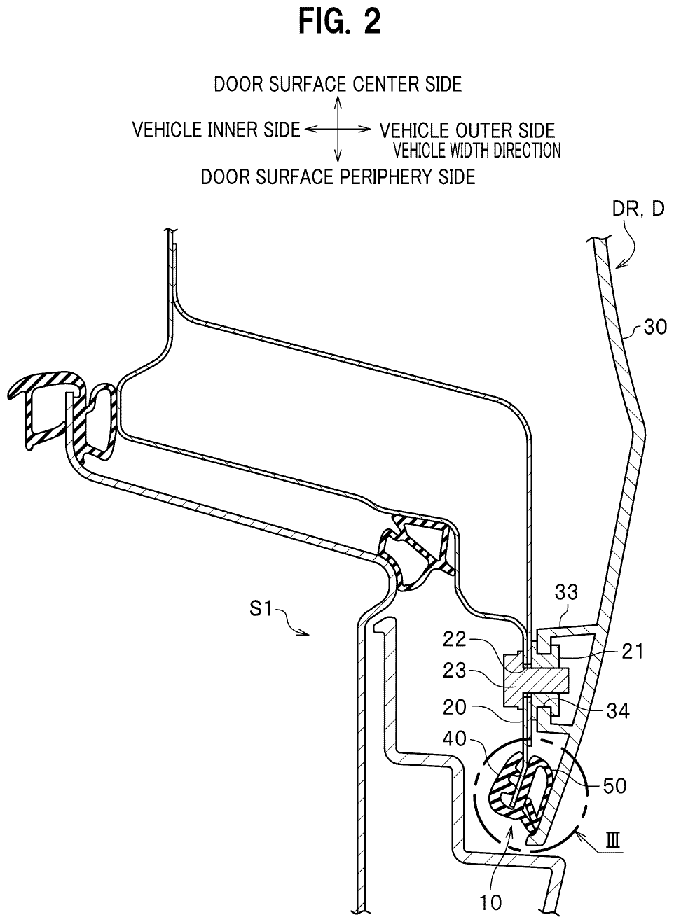

For example, the vehicle seal structure S1 is set in a lower peripheral portion of the rear seat door DR and a rear peripheral portion of the front seat door DF, and the like (see FIGS. 2 to 4).

Seal members 10 that form the vehicle seal structure S1 of the present embodiment and that are arranged in the lower peripheral portion of the rear seat door DR and the rear peripheral portion of the front seat door DF are separate members. However, the seal members 10 have the same cross-sectional shape.

Specifically, the rear peripheral portion of the front seat door DF is configured similarly to the lower peripheral portion of the rear seat door DR.

Accordingly, in the present embodiment, both of the front seat door DF and the rear seat door DR are referred to as doors D, and a configuration of a peripheral portion of each door D will be explained.

Each door D is formed of a so-called hinged door. A front edge portion of the door is supported on a front portion of the corresponding ingress-egress opening via a hinge (not shown), and a rear edge side of the door swings.

The door D includes an inner panel 20 and an outer panel 30.

The vehicle seal structure S1 of the present embodiment is arranged in a state where the seal member 10 is held between the inner panel 20 and outer panel 30, and seals a space between the inner panel 20 and the outer panel 30.

Hereinafter, the state where the seal member 10 is held between the outer panel 30 and the inner panel 20 is referred to as a seal held state.

The inner panel 20 is formed by joining multiple plate members made of metal.

A slide nut 21 is provided on the inner panel 20 while protruding from a plate surface closer to a vehicle outer side (hereinafter, referred to as inner panel outer surface 20a) of the inner panel 20.

The outer panel 30 is formed of a plate-shaped resin member, and is arranged above the inner panel outer surface 20a along a plate surface of the inner panel 20.

Moreover, the outer panel 30 includes a general portion 31 and an extended portion 32.

The general portion 31 extends in a direction along a door surface to form a main body portion of the outer panel 30. Further, a plate surface closer to a vehicle outer side (hereinafter, referred to as an outer panel outer surface 30a) of the general portion 31 forms a design surface of the door D.

Moreover, a slide rail 33 is provided on a plate surface closer to a vehicle inner side (hereinafter, referred to as an outer panel inner surface 30b) of the general portion 31.

The slide rail 33 includes a rail portion 34 that allows the slide nut 21 to move above the outer panel inner surface 30b.

Allowing the slide nut 21 to move on the rail portion 34 enables the outer panel 30 to move above the inner panel outer surface 20a along the plate surface of the inner panel 20.

Moreover, allowing the outer panel 30 to move above the inner panel 20 prevents occurrence of warping caused by a difference in coefficient of thermal expansion between the inner panel 20 and the outer panel 30.

Note that arranging the slide nut 21 on the rail portion 34 and linking the slide nut 21 to the rail portion 34 causes the outer panel 30 to be held above the inner panel outer surface 20a.

The slide nut 21 is not joined to the inner panel 20 by welding or the like, and is arranged to be attachable to and detachable from the inner panel 20.

Specifically, the slide nut 21 is installed on the inner panel 20 by screwing a bolt 23 inserted in a bolt hole 22 opened in the inner panel 20 with the slide nut 21 temporarily attached to the slide rail 33.

The extended portion 32 has a cross section with a substantially trapezoidal shape, and is formed integrally with the general portion 31 along a periphery of the outer panel inner surface 30b as a protrusion strip protruding from the outer panel inner surface 30b toward the vehicle inner side.

In other words, the extended portion 32 forms a step along the periphery of the outer panel inner surface 30b.

The extended portion 32 prevents water entering an inner side of the outer panel 30 from directly hitting a tight contact portion between the seal member 10 and the outer panel inner surface 30b.

Next, the seal member 10 will be explained more specifically.

The seal member 10 is made of a flexible and elastic material such as rubber.

In the seal held state, the seal member 10 is in tight contact with the outer panel inner surface 30b and the inner panel outer surface 20a by resilience, and exhibits sealing properties between the inner panel 20 and the outer panel 30.

The seal member 10 includes a base portion 40 and a panel seal portion 50.

The base portion 40 is formed of an outer wall 41, an inner wall 42, and a bottom wall 43. The outer wall 41, the inner wall 42, and the bottom wall 43 are integrally formed.

The outer wall 41 is arranged while extending along a direction from a peripheral side of the plate surface of the inner panel outer surface 20a toward a center side of the plate surface thereof.

Note that, hereinafter, the peripheral side of the plate surface of the inner panel outer surface 20a is referred to as a door surface periphery side, and the center side of the plate surface is referred to as a door surface center side.

Moreover, a direction from the door surface periphery side toward the door surface center side is referred to as a door surface center-periphery direction.

A portion of the outer wall 41 facing the inner panel outer surface 20a is set to be a flat surface (hereinafter, referred to as a base flat surface 44).

The base flat surface 44 is in tight contact with the inner panel outer surface 20a in the seal held state.

The inner wall 42 is arranged while extending along the door surface center-periphery direction of a plate surface closer to a vehicle inner side (hereinafter, referred to as an inner panel inner surface 20b) of the inner panel 20.

The inner wall 42 includes a pair of base ribs 45 protruding toward the inner panel 20, in a portion facing the inner panel inner surface 20b of the inner panel 20.

The bottom wall 43 integrally connects a peripheral side end portion of the outer wall 41 and a peripheral side end portion of the inner wall 42 to each other.

The base portion 40 forms a groove shape with a substantially U-shaped cross section by the outer wall 41, the inner wall 42, and the bottom wall 43.

The base portion 40 is arranged on the inner panel 20 via containing a periphery of the inner panel 20 inside the U-shaped groove.

The panel seal portion 50 includes a seal lip 51, a turned-back lip 52, and a stopper lip 53.

The seal lip 51 stands from a door surface center side portion of the outer wall 41 toward the outer side in the vehicle width direction to extend toward the outer panel 30. Also, the seal lip 51 extends along the outer panel inner surface 30b toward the door surface periphery side.

Specifically, the seal lip 51 forms a groove shape with a substantially V-shaped cross section together with the outer wall 41 of the base portion 40.

The seal lip 51 is flexible and elastic. A surface thereof closer to the outer panel side is in tight contact with the outer panel inner surface 30b by resilience in the seal held state.

Moreover, a shape and dimensions of the seal lip 51 are set such that a distal end of the seal lip 51 does not come into contact with the extended portion 32 of the outer panel 30 in the seal held state.

The turned-back lip 52 stands from the distal end portion of the seal lip 51 toward the door surface center side of the inner panel 20 while extending toward the inner panel 20 to be tilted with respect to the inner panel 20.

Specifically, the turned-back lip 52 stands while forming an acute angle with the seal lip 51.

Moreover, a shape and dimensions of the turned-back lip 52 are set such that a distal end of the turned-back lip 52 is in contact with and held by the outer wall 41 of the base portion 40 in the seal held state.

The stopper lip 53 is located closer to the door surface periphery side than the turned-back lip 52. Here, the stopper lip 53 stands from a portion where the outer wall 41 and the bottom wall 43 of the base portion 40 are connected to each other, toward a boundary portion between the general portion 31 and the extended portion 32 of the outer panel 30.

Further, a shape and dimensions of the stopper lip 53 are set such that a distal end of the stopper lip 53 is in contact with and held by a portion of the outer panel 30 closer to the general portion 31 of the boundary portion between the general portion 31 and the extended portion 32 in the seal held state.

Next, operations of the seal member 10 will be explained more specifically.

In the seal held state in which the seal member 10 is held between the outer panel 30 and the inner panel 20, the seal member 10 configured as described above tries to return to the original shape, and thereby resilience operates.

This resilience causes the outer wall 41 of the base portion 40 to come into tight contact with the inner panel outer surface 20a of the inner panel 20, thereby to cause the seal lip 51 to come into tight contact with the outer panel inner surface 30b.

Moreover, the resilience causes the distal end of the turned-back lip 52 to come into contact with a vehicle outer side surface 41a of the outer wall 41, thereby to cause the distal end of the stopper lip 53 to come into contact with the outer panel inner surface 30b of the general portion 31.

The seal member 10 seals a space between the inner panel 20 and the outer panel 30 by causing the portions to stick to and come into tight contact with one another as described above.

For example, when water enters a space between the panels in rain or car wash, water is first blocked by the stopper lip 53. Then, water not blocked by the stopper lip 53 is blocked by the seal lip 51 and the turned-back lip 52.

Further, water not blocked by the turned-back lip 52 is guided into the V-shaped groove formed by the seal lip 51 and the outer wall 41, and moves in the V-shaped groove to be discharged to the outside from a discharge portion (not shown).

Moreover, the resilience operation causes a component force of the resilience to act on the base portion 40 from the door surface periphery side toward the door surface center side.

This phenomenon prevents detachment of the seal member 10 from the inner panel 20.

Furthermore, when the seal member 10 moves from the inner panel 20 toward the door surface periphery side, the distal end of the stopper lip 53 engages with a base portion of the extended portion 32, thereby to prevent detachment of the seal member 10.

Next, operations and effects of the present embodiment will be explained more specifically.

In the vehicle seal structure S1 of the present embodiment, the seal member 10 is held between the inner panel 20 made of metal and the outer panel 30 made of resin.

Here, the outer panel 30 is arranged to be movable along a door surface of the inner panel 20.

The vehicle seal structure S1 can thereby secure the sealing properties in the door surface periphery portion while tolerating a difference in coefficient of thermal expansion between the inner panel 20 and the outer panel 30.

Specifically, the vehicle seal structure S1 can prevent a decrease in sound isolating properties and occurrence of warping caused by the difference in coefficient of thermal expansion between the outer panel 30 and the inner panel 20 thus raised by adopting the outer panel 30 made of resin.

Moreover, securing the sealing properties enables a simpler manufacturing process, i.e., applying only a rust-proofing paint when painting the inner panel 20.

This feature can reduce an exhaust amount of carbon dioxide in vehicle manufacturing, and contribute to mitigation of climate change or reduction of influences thereof.

In the vehicle seal structure S1 of the present embodiment, the seal member 10 is formed of the base portion 40 and the panel seal portion 50.

The base portion 40 has a substantially-U shaped groove shape in the cross section, and is arranged containing a periphery of the inner panel 20 in the U-shaped groove.

Further, the panel seal portion 50 is in tight contact with the outer panel inner surface 30b of the outer panel 30 in the seal held state.

Adopting such a configuration causes the periphery of the inner panel 20 to be covered with the base portion 40. Thus, the periphery of the inner panel 20 can be prevented from being exposed to water and sunlight.

This configuration can prevent generation of rust in the periphery of the inner panel 20 and make generated rust less visible.

Further, containing the periphery of the inner panel 20 in the U-shaped groove of the base portion 40 causes the seal member 10 to be fixed, thereby to prevent misalignment of the panel seal portion 50.

As a result, the sealing properties between the inner panel 20 and the outer panel 30 can be improved.

In the vehicle seal structure S1 of the present embodiment, the seal lip 51 extends from an end portion of the outer wall 41 forming the base portion 40 closer to the door surface center side toward the outer panel 30, and further extends along the door surface periphery side of the outer panel 30.

When water enters a space between the panels in rain or car wash, such a configuration allows the water to be received by the V-shaped groove formed by the seal lip 51 and the outer wall 41.

Accordingly, water entering into the space between the outer panel 30 and the inner panel 20 from the end portion of the seal lip 51 can be prevented.

Further, improving the sealing properties can enhance the sound insulating properties.

In the vehicle seal structure S1 of the present embodiment, the turned-back lip 52 stands from the distal end portion of the seal lip 51 toward the door surface center side of the inner panel 20 to be tilted with respect to the inner panel 20.

Adopting such a configuration causes resilience of the turned-back lip 52 to be applied to the distal end portion of the seal lip 51.

This phenomenon can increase force that brings the seal lip 51 into tight contact with the outer panel inner surface 30b, and further improve the sealing properties.

Moreover, since reaction force that the seal lip 51 receives from the outer panel inner surface 30b presses the outer wall 41 of the base portion 40 toward the door surface center side via the turned-back lip 52, pull-in force increases, and the base portion 40 can be prevented from moving toward the door surface periphery side.

Furthermore, increasing the force that brings the seal lip 51 into tight contact with the outer panel inner surface 30b can improve the sound insulating properties.

In the vehicle seal structure S1 of the present embodiment, the stopper lip 53 is located closer to the door surface periphery side than the turned-back lip 52.

Adopting such a configuration causes the stopper lip 53 to reduce an amount of water entering the V-shaped groove formed by the seal lip 51 and the outer wall 41, by interfering with the water. In the vehicle seal structure S1 of the present embodiment, the extended portion 32 is formed integrally with the general portion 31 in a periphery of the outer panel inner surface 30b to extend along a peripheral direction of the outer panel inner surface 30b.

Further, the extended portion 32 has a cross section with a substantially trapezoidal shape, and forms a step in the periphery of the outer panel inner surface 30b, as a protrusion strip protruding from the outer panel inner surface 30b toward the vehicle inner side.

A distal end of the seal lip 51 is in contact with the general portion 31 side of the boundary portion between the general portion 31 and the extended portion 32.

Adopting such a configuration causes water with high momentum to hit the extended portion 32 instead of the distal end of the seal lip 51 in rain or car wash. Thus, the vehicle seal structure S1 can exhibit higher sealing properties.

### Second Embodiment

Next, a vehicle seal structure S2 of a second embodiment will be explained in detail with reference to a right portion of FIG. 4.

The vehicle seal structure S2 of the present embodiment is provided with a configuration that seals a space between a rear edge portion of the front seat door DF and a front edge portion of the rear seat door DR in a center pillar portion of the vehicle V.

Note that, in the explanation, the same elements as those in the above-mentioned first embodiment are denoted by the same reference signs, and overlapping explanation is omitted.

In the vehicle seal structure S2 of the present embodiment, a configuration of the outer panel 30 and a configuration of the seal member 10 are different from those in the first embodiment.

The outer panel 30 of the present embodiment does not include the extended portion 32, but includes only the general portion 31.

Specifically, a peripheral portion of the outer panel inner surface 30b is a flat surface continuous from the general portion 31.

Further, the seal member 10 includes an inter-panel seal 54.

Note that, in the present embodiment, the outer panel 30 of the front seat door DF is an exterior panel PF adjacent to the outer panel 30 of the rear seat door DR.

The inter-panel seal 54 extends from a distal end of the seal lip 51 toward the door surface periphery side.

In the seal held state, the seal lip 51 is in tight contact with the outer panel inner surface 30b. Additionally, the inter-panel seal 54 is in contact with an extended portion 32 of the adjacent exterior panel PF (i.e., an outer panel 30 of the front seat door DF) by resilience.

Specifically, providing the inter-panel seal 54 closes a gap between the outer panel 30 and the exterior panel PF.

Closing the gap blocks direct sunlight entering the insides of the inner panel 20 and the door D from the gap, and prevents entrance of rain water and the like.

Moreover, the turned-back lip 52 and the stopper lip 53 are changed associated with providing the inter-panel seal 54.

The turned-back lip 52 is changed to stand from an intermediate portion of the inter-panel seal 54 toward the door surface center side of the inner panel 20 while extending toward the inner panel 20 to be tilted with respect to the inner panel 20.

The stopper lip 53 is changed such that a distal end of the stopper lip 53 is in contact with a distal end portion of the inner surface of the inter-panel seal 54 in the seal held state.

In the seal heled state, the stopper lip 53 deforms by warping, and resilience of the stopper lip 53 brings the inter-panel seal 54 into contact with the adjacent exterior panel PF more strongly.

As described above, the present embodiment can provide operations and effects similar to those of the first embodiment.

Further, adopting such a configuration can cause the vehicle seal structure S2 to have sealing properties between the outer panel 30 and the adjacent exterior panel PF without an increase in the number of parts.

Specifically, providing the inter-panel seal 54 blocks direct sunlight entering insides of the inner panel 20 and the door D from a gap between the outer panel 30 and the exterior panel PF, and prevents entrance of rain water and the like.

This feature reduces aging of the paint inside the inner panel 20 and the door D. Thus, required weather resistance can be sufficiently achieved by simplifying a painting process.

Further, simplifying the painting process can reduce an exhaust amount of carbon dioxide in the vehicle manufacturing, and contribute to the mitigation of climate change or the reduction of influences thereof.

### Third Embodiment

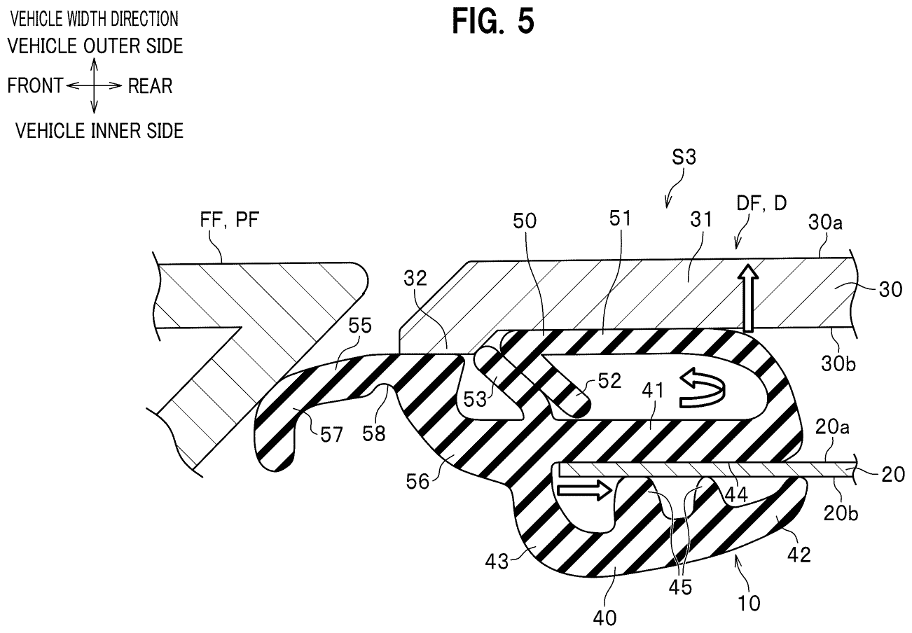

Next, a vehicle seal structure S3 of a third embodiment will be explained in detail with reference to FIG. 5.

Note that, in the explanation, the same elements as those in the above-mentioned first embodiment are denoted by the same reference signs, and overlapping explanation is omitted.

The vehicle seal structure S3 of the present embodiment is provided in a configuration that seals a space between the front seat door DF and a front fender FF in a front edge portion of the front seat door DF.

The outer panel 30 of the front fender FF is an exterior panel PF adjacent to the outer panel 30 of the front seat door DF.

Further, the vehicle seal structure S3 of the present embodiment has a configuration of an inter-panel seal 55 for the form in which the outer panel 30 includes the extended portion 32.

Configurations of the base portion 40, the seal lip 51, the turned-back lip 52, and the stopper lip 53 are the same as those in the first embodiment.

Moreover, the seal member 10 includes the inter-panel seal 55.

The inter-panel seal 55 includes a contact portion 56, an elastic contact portion 57, and a constriction portion 58.

The contact portion 56 has a cross section with a substantially-L shape, and stands from the bottom wall 43 of the base portion 40 toward the extended portion 32 of the outer panel 30.

A distal end of the contact portion 56 is formed to be a flat surface capable of coming into tight contact with an end surface of the extended portion 32.

The elastic contact portion 57 extends from the contact portion 56 toward the adjacent exterior panel PF (i.e., a front fender FF) toward the door surface periphery side, and is in elastic contact with an inner surface side of the exterior panel PF.

The constriction portion 58 is a portion that is set between the contact portion 56 and the elastic contact portion 57 and that has a small thickness dimension.

When the front seat door DF is in a closed state, the inter-panel seal 55 is bent in the constriction portion 58, resulting in maintenance of sealing between the contact portion 56 and the extended portion 32 and sealing between the elastic contact portion 57 and the adjacent exterior panel PF.

When water with high momentum is blown toward a space between the outer panel 30 and the front fender FF in the closed state of the front seat door DF, bending of the inter-panel seal 55 in the constriction portion 58 allows the state where the contact portion 56 is in contact with the end surface of the extended portion 32 to be maintained.

In other words, providing the inter-panel seal 55 closes a gap between the outer panel 30 and the exterior panel PF.

Closing the gap blocks direct sunlight entering insides of the inner panel 20 and the door D from the gap, thereby to prevent entrance of rain water and the like.

As described above, the present embodiment can provide operations and effects similar to those of the second embodiment.

Further, adopting such a configuration can cause the inter-panel seal 55 to deform by warping in the constriction portion 58 and elastically deform when water with high momentum is blown toward a space between the outer panel 30 and the adjacent exterior panel PF in rain or car wash.

This feature allows the inter-panel seal 55 to maintain a state where the contact portion 56 is in contact with the end surface of the extended portion 32. Thus, the vehicle seal structure S3 can exhibit higher sealing properties between the outer panel 30 and the inner panel 20.

Specifically, providing the inter-panel seal 55 blocks direct sunlight entering insides of the inner panel 20 and the door D from the gap between the outer panel 30 and the exterior panel PF, and prevents entrance of rain water and the like.

This feature reduces aging of the paint inside the inner panel 20 and the door D. Thereby, required weather resistance can be sufficiently achieved by simplifying a painting process.

Further, simplifying the painting process can reduce an exhaust amount of carbon dioxide in the vehicle manufacturing, and contribute to the mitigation of climate change or the reduction of influences thereof.

### Fourth Embodiment

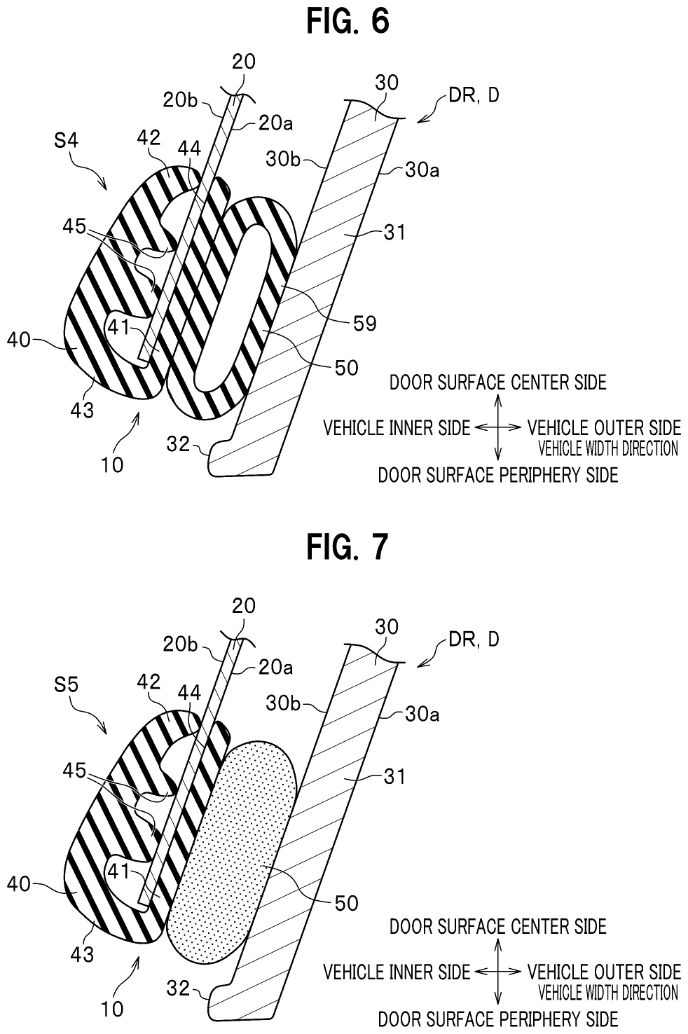

Next, a vehicle seal structure S4 of a fourth embodiment will be explained in detail with reference to FIG. 6.

Note that, in the explanation, the same elements as those in the above-mentioned first embodiment are denoted by the same reference signs, and overlapping explanation is omitted.

The vehicle seal structure S4 of the present embodiment is different from the first embodiment in a configuration of the panel seal portion 50.

The panel seal portion 50 of the present embodiment includes a hollow seal 59 formed in a cylindrical shape with an elliptical cross section.

In the seal held state, the hollow seal 59 comes into tight contact with the outer panel inner surface 30b with the cylindrical shape being crushed, and seals a space between the inner panel 20 and the outer panel 30.

Adopting such a configuration can provide operation and effects similar to those of the first embodiment.

### Fifth Embodiment

Next, a vehicle seal structure S5 of a fifth embodiment will be explained in detail with reference to FIG. 7.

Note that, in the explanation, the same elements as those in the above-mentioned first embodiment are denoted by the same reference signs, and overlapping explanation is omitted.

The vehicle seal structure S5 of the present embodiment is different from the first embodiment in a configuration of the panel seal portion 50.

The panel seal portion 50 of the present embodiment uses a sponge-like member made of foamed rubber such as EPT-Sealer (registered trademark).

In the seal held state, the panel seal portion 50 is in tight contact with the outer panel inner surface 30b with the foamed rubber being crushed, and seals a space between the inner panel 20 and the outer panel 30.

Adopting such a configuration can provide operation and effects similar to those of the first embodiment.

Although the panel seal portion 50 is configured to be arranged in the peripheral edge of the inner panel 20 via the base portion 40 having the U-shaped cross section in the first to fifth embodiments described above, the present disclosure is not limited to this configuration.

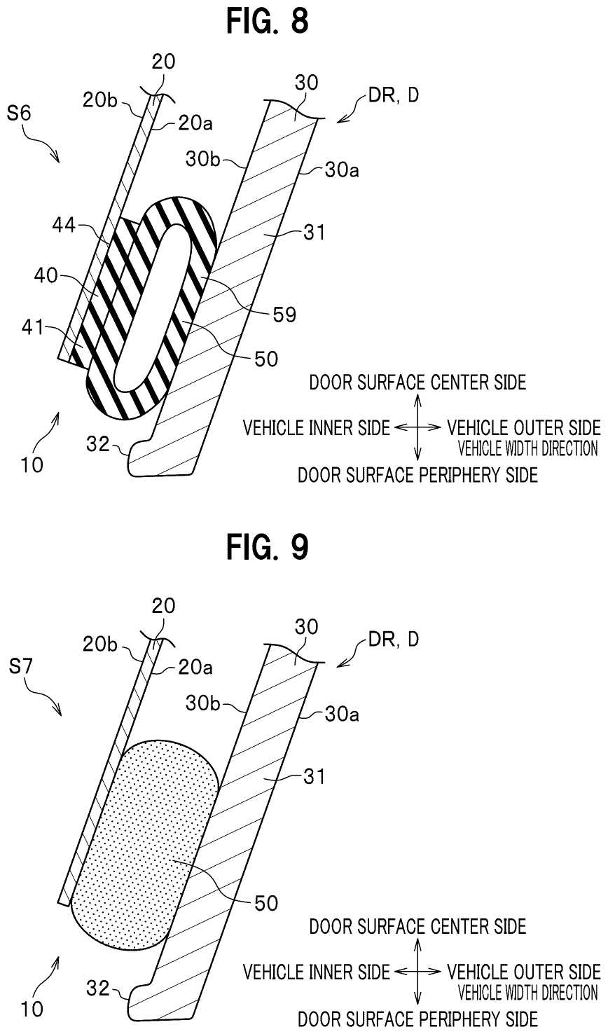

For example, there may be adopted a form in which the base portion 40 has a flat plate shape including only the outer wall 41, and is installed on the inner panel 20 by using various means such as a clip, a bolt, a double-sided tape, and an adhesive (see FIG. 8).

Such a form can also provide operations and effects similar to those described above.

Moreover, for example, there may be adopted a form in which the panel seal portion 50 is directly installed on the inner panel 20 without the base portion 40 by using various means such as a clip, a bolt, a double-sided tape, and an adhesive (see FIG. 9).

Such a form can also provide operations and effects similar to those described above.

What is claimed is:

1. A vehicle seal structure, comprising:
an inner panel made of a metal forming a door supported to be capable of opening and closing an ingress-egress opening,
an outer panel made of a resin arranged above a plate surface of the inner panel closer to a vehicle outer side to be movable along a door surface of the inner panel, and
a seal member held between the inner panel and the outer panel.

2. The vehicle seal structure according to claim 1, wherein
the seal member comprises:
a base portion having a groove shape with a substantially U-shaped cross section and arranged to have a periphery of the inner panel inside a U-shaped groove, and
a panel seal portion formed from the base portion toward the outer panel, and is in tight contact with a plate surface of the outer panel closer to a vehicle inner side with the seal member held between the inner panel and the outer panel.

3. The vehicle seal structure according to claim 1, wherein
the seal member comprises:
an inter-panel seal being in contact with the outer panel as well as an exterior panel adjacent to the outer panel.

4. The vehicle seal structure according to claim 1, wherein
the seal member comprises:
a base portion arranged on the inner panel, and
a seal lip extending from an outer wall forming the base portion to the outer panel, and extending along a door surface periphery side of the outer panel.

5. The vehicle seal structure according to claim 4, wherein
the seal member comprises a turned-back lip extending from an edge portion of the seal lip toward a door surface center side of the inner panel, and standing to be tilted with respect to the inner panel, and
the base portion has a groove shape with a U-shaped cross section, and is arranged to have a periphery of the inner panel inside a U-shaped groove.

6. The vehicle seal structure according to claim 5, wherein
the seal member comprises a stopper lip located closer to a door surface periphery side than the turned-back lip and standing from the base portion toward the outer panel.

7. The vehicle seal structure according to claim 4, wherein
the outer panel comprises:
a general portion forming a main body portion of the outer panel,
an extended portion integrally formed with the general portion to protrude as a protrusion strip from a plate surface closer to a vehicle interior side of the general portion toward a vehicle interior side, wherein
an edge of the seal lip is in contact with the outer panel closer to a door surface center side than the extended portion of the general portion.

8. The vehicle seal structure according to claim 1, wherein
the seal member includes a hollow seal having a cylindrical cross section, and is in tight contact with a plate surface of the outer panel closer to a vehicle inner side with the seal member held between the inner panel and the outer panel.
